(19) United States
(12) Patent Application Publication
(10) Pub. No.: US 2026/0312908 A1
(43) Pub. Date: Oct. 8, 2026

(54) Multi-message transmission optimization

(71) Applicant: Mellanox Technologies, Ltd., Yokneam (IL)

(72) Inventors: Dotan Barak, Zichron Ya'akov (IL); Shira Levy, Haifa (IL)

(21) Appl. No.: 19/359,703

(22) Filed: Oct. 16, 2025

(30) Foreign Application Priority Data
Apr. 2, 2025 (IL) 320048

(51) Int. Cl. H04L 47/2475; H04L 12/18; H04L 47/36; H04L 67/1097

(52) U.S. Cl. CPC H04L 47/2475; H04L 12/1886; H04L 47/36; H04L 67/1097

(57) ABSTRACT

In one embodiment, a network-enabled device includes a host interface to connect with a host computing device, packet processing circuitry to receive a work request generated by an application running on the host computing device, the work request specifying at least one buffer and being associated with a queue pair configured for a transport protocol, process the work request to automatically segment the at least one buffer into a plurality of messages, each message having a message size, and transmit the plurality of messages over a network according to the transport protocol, and a network interface to facilitate transmission of the plurality of messages over the network.

### FIELD OF THE DISCLOSURE

The present disclosure relates to communication systems, and more particularly but not exclusively to work request processing.

### BACKGROUND

Remote Direct Memory Access (RDMA) technology enables high-performance networking by allowing direct memory access between networked computers without involving the operating system kernel or CPU in data transfer operations. RDMA supports multiple transport types, including Reliable Connected (RC), Unreliable Connected (UC), and Unreliable Datagram (UD) protocols, each offering different characteristics for various networking applications.

In RDMA systems, applications typically interact with the network hardware through Work Queue Elements (WQEs) that describe data transmission operations. These WQEs are posted to send queues, where hardware processes them and generates corresponding Completion Queue Entries (CQEs) to indicate transmission status. The hardware manages the segmentation of data into packets according to protocol-specific constraints such as Maximum Transfer Unit (MTU) size limitations configured in Queue Pairs (QPs).

Different transport protocols handle message transmission in distinct ways. RC transport provides reliable, connection-oriented communication where messages may be automatically segmented by hardware into multiple packets. UD transport operates as an unreliable, connectionless protocol that supports both unicast and multicast transmission, with each message traditionally corresponding to a single packet constrained by MTU size. UC transport provides unreliable, connection-oriented communication with characteristics similar to RC but without reliability guarantees.

Current RDMA implementations require applications to manage data segmentation manually when transmitting large buffers that exceed protocol-specific size constraints. This approach involves creating multiple WQEs for different portions of the data, posting them individually to send queues, and subsequently handling multiple completion events. Such operations consume CPU processing resources and PCI bandwidth, particularly when applications frequently transmit large amounts of data in scenarios such as video streaming, audio transmission, or multicast data distribution.

The management of multiple WQEs and CQEs for conceptually single data transmission operations can limit the practical efficiency of data transmission systems. Queue capacity constraints may further compound these considerations, as the number of WQEs grows with the amount of data to be transmitted, potentially affecting queue management strategies for large data transmissions.

### OVERVIEW

There is provided in accordance with an embodiment of the present disclosure, a network-enabled device, comprising a host interface to connect with a host computing device, packet processing circuitry to receive a work request generated by an application running on the host computing device, the work request specifying at least one buffer and being associated with a queue pair configured for a transport protocol, process the work request to automatically segment the at least one buffer into a plurality of messages, each message having a message size, and transmit the plurality of messages over a network according to the transport protocol, and a network interface to facilitate transmission of the plurality of messages over the network.

Further in accordance with an embodiment of the present disclosure, each message corresponds to a single packet that does not exceed a maximum transfer unit size.

Still further in accordance with an embodiment of the present disclosure, each message is to be transmitted as multiple packets according to the transport protocol.

Additionally, in accordance with an embodiment of the present disclosure, the work request specifies a custom message size, and the packet processing circuitry is to segment the at least one buffer into the plurality of messages using the custom message size.

Moreover, in accordance with an embodiment of the present disclosure, the packet processing circuitry is to maintain an internal buffer offset pointer to track a current position within the at least one buffer during segmentation.

Further in accordance with an embodiment of the present disclosure, the packet processing circuitry is to iteratively update the buffer offset pointer and a remaining buffer length until all of the at least one buffer has been segmented.

Still further in accordance with an embodiment of the present disclosure, the packet processing circuitry is to calculate the message size for each message as a minimum of the remaining buffer length, and a configured message size.

Additionally, in accordance with an embodiment of the present disclosure, the transport protocol supports multicast transmission, and the plurality of messages are transmitted as multicast messages.

Moreover, in accordance with an embodiment of the present disclosure, each message in the plurality of messages includes appropriate sequencing according to the transport protocol.

Further in accordance with an embodiment of the present disclosure, the packet processing circuitry is to receive multiple work requests associated with different buffers for the queue pair, and wherein different ones of the work requests specify different custom message sizes.

Still further in accordance with an embodiment of the present disclosure, the packet processing circuitry is to generate a single completion notification for processing by the application upon completion of transmission of all of the messages corresponding to the at least one buffer.

Additionally, in accordance with an embodiment of the present disclosure, the work request is a single work queue element.

There is provided in accordance with another embodiment of the present disclosure, a computing system, comprising a host computing device running an application, a network-enabled device coupled to the host computing device, the network-enabled device comprising a host interface to connect with the host computing device, packet processing circuitry to receive a work request generated by the application, the work request specifying at least one buffer and being associated with a queue pair configured for a transport protocol, process the work request to automatically segment the at least one buffer into a plurality of messages, each message having a message size, and transmit the plurality of messages over a network according to the transport protocol, and a network interface to facilitate transmission of the plurality of messages over the network, and a remote computing device configured to receive the plurality of messages through a plurality of receive work requests.

Moreover, in accordance with an embodiment of the present disclosure, the remote computing device comprises a plurality of receive buffers, each receive buffer corresponding to one of the plurality of messages.

Further in accordance with an embodiment of the present disclosure, each message corresponds to a single packet that does not exceed a maximum transfer unit size.

Still further in accordance with an embodiment of the present disclosure, each message may be transmitted as multiple packets according to the transport protocol.

Additionally, in accordance with an embodiment of the present disclosure, the work request specifies a custom message size, and the packet processing circuitry is to segment the at least one buffer into the plurality of messages using the custom message size.

Moreover, in accordance with an embodiment of the present disclosure, the transport protocol supports multicast transmission, and the plurality of messages are transmitted as multicast messages.

Further in accordance with an embodiment of the present disclosure, the packet processing circuitry is to receive multiple work requests associated with different buffers for the queue pair, and wherein different ones of the work requests specify different custom message sizes.

Still further in accordance with an embodiment of the present disclosure, the packet processing circuitry is to generate a single completion notification for processing by the application upon completion of transmission of all of the messages corresponding to the at least one buffer.

Additionally, in accordance with an embodiment of the present disclosure, the work request is a single work queue element.

There is also provided in accordance with still another embodiment of the present disclosure, a method for multi-message transmission optimization, comprising receiving a work request generated by an application running on a host computing device, the work request specifying at least one buffer and being associated with a queue pair configured for a transport protocol, processing the work request to automatically segment the at least one buffer into a plurality of messages, each message having a message size, and transmitting the plurality of messages over a network according to the transport protocol.

### BRIEF DESCRIPTION OF THE DRAWINGS

The present disclosure will be understood from the following detailed description, taken in conjunction with the drawings in which:

FIG. 1 is a partly pictorial, partly block diagram view of a computing system, constructed and operative in accordance with an embodiment of the present disclosure;

FIG. 2 is a more detailed view of packet processing circuitry in the system of FIG. 1;

FIG. 3 is a flowchart including steps in a method of operation of the host computing device of FIG. 1;

FIG. 4 is a flowchart including steps in a method of multi-message transmission optimization by the network enabled device of FIG. 1;

FIG. 5 is a flowchart including steps in a method of processing messages at a remote computing device of FIG. 1; and

FIG. 6 is a block diagram that schematically illustrates a computing system, e.g., a data center or a High-Performance Computing (HPC) cluster, in accordance with an embodiment of the present disclosure.

### DESCRIPTION OF EXAMPLE EMBODIMENTS

### Overview of Example Embodiments

Current RDMA transport implementations create significant inefficiencies when applications need to transmit large buffers that require segmentation into multiple messages. Applications must manually segment their data and create separate Work Queue Elements (WQEs) for each segment, resulting in substantial overhead in both CPU processing and PCI bandwidth utilization. This segmentation process requires the application to repeatedly post multiple WQEs to the send queue, leading to redundant operations and increased system resource consumption. In Unreliable Datagram (UD) transport, this problem is particularly pronounced when transmitting data larger than the Maximum Transfer Unit (MTU) size, as each message is limited to a single packet. In Reliable Connected (RC) transport, while larger messages are supported, applications still need to post multiple WQEs when sending multiple discrete messages from a large buffer, and the protocol may impose size limitations such as a 2-gigabyte maximum message size in some implementations.

The requirement to handle multiple completion notifications or Completion Queue Entries (CQEs) corresponding to each transmitted segment further compounds the problem, as applications must track and process numerous completion events for what may conceptually represent a single data transmission operation. This overhead becomes particularly problematic for applications that frequently transmit large amounts of data, such as video streaming, audio transmission, or multicast data distribution scenarios, where the CPU cycles spent managing multiple WQEs and CQEs could otherwise be utilized for application-specific processing. Additionally, the current approach may limit the practical size of data that can be efficiently transmitted, as the number of required WQEs grows with the number of messages to be sent, potentially exhausting the send queue capacity and forcing applications to implement complex queue management strategies to handle large data transmissions.

There is a need for a solution that eliminates the requirement for applications to create multiple WQEs and handle multiple CQEs for large buffer transmissions while maintaining compatibility with existing RDMA receivers. Such a solution would significantly reduce CPU overhead and PCI bandwidth consumption while preserving the characteristics of the underlying transport protocol, including support for multicast transmission in applicable transport types. The importance of addressing this issue is underscored by the growing demand for high-performance data transmission in applications such as high-frequency trading, real-time multimedia streaming, and large-scale data distribution systems where transmission efficiency directly impacts system performance and user experience.

Embodiments of the present disclosure address at least some of the above drawbacks by providing a hardware-based optimization for RDMA transport protocols or any suitable protocol that enables efficient transmission of large data using a single work request or Work Queue Element (WQE), where applications can post one WQE containing one or more buffers, which the hardware automatically segments the buffer(s) into multiple messages without requiring application-level buffer management or multiple WQE postings.

In some embodiments, the hardware processes a single WQE containing one or more buffers and automatically splits the buffer(s) into multiple messages, each conforming to size constraints appropriate for the transport type. Each buffer may have its own length, address, and memory key. The message size for segmentation can be configured in various ways, such as matching the MTU size, conforming to transport-specific limitations, or according to a specific size defined within the WQE itself, providing flexibility for different application requirements. In some cases, the system may support transmission of buffers exceeding size limitations that may be present in conventional transport implementations, enabling large-scale data transmission without traditional size restrictions.

In some embodiments, the hardware maintains an internal buffer offset pointer that tracks the current position within the buffer(s), enabling sequential processing of buffer segments without requiring additional WQEs from the application. The hardware segmentation process may follow a systematic approach where the total buffer length is continuously evaluated against the remaining data to be transmitted. For each iteration, the hardware calculates the message length based on the remaining buffer length and the configured message size, which may be set according to transport-specific constraints, MTU size, or a custom size specified in the WQE. The hardware then constructs a message containing the data from the current buffer offset position, transmits the message according to the appropriate transport protocol specifications, and updates the buffer offset and remaining buffer length accordingly. This process continues until the entire buffer(s) has been transmitted, at which point the hardware may generate a single CQE to signal completion of the entire transmission operation.

In some cases, the system may provide flexibility in message size configuration through per-WQE attributes, allowing different segmentation strategies for different transmission requirements within the same Queue Pair (QP). For instance, an application might configure one WQE to segment one or more buffers into smaller messages for certain requirements, while a subsequent WQE on the same QP might use larger messages for different efficiency considerations. This per-WQE configurability may provide advantages over approaches where segmentation parameters are fixed at the QP level and cannot be modified on a per-transmission basis.

In some embodiments, the receiver-side operation may remain unchanged from standard protocol behavior, ensuring compatibility with existing RDMA implementations. Each segmented message appears to the receiver as an independent message with appropriate headers for the transport type. The receiving application posts the appropriate number of receive WQEs to handle the incoming messages, as the receiver may have no knowledge of the sender-side optimization. This transparency may ensure that existing systems can interoperate seamlessly with systems implementing the above.

Embodiments of the present disclosure improve the way a computer or other processing device works by: providing better computer performance through reduced CPU overhead for managing multiple WQEs and CQEs; providing higher processing speed by eliminating redundant WQE posting operations; providing less latency by streamlining the data transmission process; reducing bandwidth requirements for PCI connections by minimizing repetitive queue operations; increasing data access speed through more efficient buffer processing; reducing power consumption by decreasing CPU cycles required for queue management operations.

### DEFINITIONS

As used herein, the term "network-enabled device" may refer to a hardware component or system capable of connecting to and communicating over a network, such as a network interface controller (NIC) or data processing unit (DPU) or a network enabled graphics processing unit (GPU). Examples include Ethernet adapters and InfiniBand host channel adapters.

As used herein, the term "network interface" may refer to a physical or logical connection point that enables a device to communicate with a network, facilitating the transmission and reception of data packets. Examples include Ethernet ports and wireless network adapters.

As used herein, the term "network" may refer to an interconnected system of computing devices that can communicate and share resources with each other through various communication protocols and physical or wireless connections. Examples include local area networks (LANs) and wide area networks (WANs).

As used herein, the term "host interface" may refer to a connection mechanism that enables communication between a network-enabled device and a host computing system, typically through standardized interfaces. Examples include PCIe interfaces and USB connections.

As used herein, the term "host computing device" may refer to a primary computing system that runs applications and manages computational tasks, often serving as the main processing unit in a networked environment. Examples include servers and desktop computers.

As used herein, the term "queue pair" may refer to a communication endpoint in RDMA systems consisting of a send queue and a receive queue that are configured for a specific transport protocol. Examples include RC (Reliable Connected) queue pairs and UD (Unreliable Datagram) queue pairs.

As used herein, the term "work request" may refer to a data structure that describes a network operation to be performed by hardware, containing information about data buffers and transmission parameters. Examples include send requests and receive requests in RDMA systems.

As used herein, the term "work queue element (WQE)" may refer to an individual entry in a work queue that represents a specific work request posted by an application for processing by network hardware. Examples include send WQEs and receive WQEs in RDMA implementations.

As used herein, the term "completion notification" may refer to a signal or data structure generated by hardware to inform an application that a previously submitted work request has been processed or completed. Examples include completion queue entries (CQEs) and interrupt notifications.

As used herein, the term "transport protocol" may refer to a set of rules and procedures that govern how data is transmitted over a network, defining reliability, connection characteristics, and message handling. Examples include RDMA RC (Reliable Connected) and UD (Unreliable Datagram) protocols.

As used herein, the term "buffer" may refer to a contiguous region of memory that stores data to be transmitted or received over a network, typically specified by an address, length, and memory key. Examples include send buffers containing outgoing data and receive buffers for incoming data.

As used herein, the term "message" may refer to a discrete unit of data that is transmitted over a network according to a specific transport protocol, potentially consisting of one or more packets. Examples include RDMA send messages and multicast messages.

As used herein, the term "message size" may refer to the amount of data contained within a single message, typically measured in bytes and subject to protocol-specific constraints. Examples include MTU-sized messages and custom-sized message segments.

As used herein, the term "packet" may refer to a formatted unit of data transmitted over a network that includes headers and payload information according to network protocol specifications. Examples include Ethernet frames and InfiniBand packets.

As used herein, the term "maximum transfer unit size" may refer to the largest amount of data that can be transmitted in a single packet over a network link without fragmentation. Examples include 1500-byte Ethernet MTU and 4096-byte InfiniBand MTU.

As used herein, the term "custom message size" may refer to a user-specified or application-defined size for segmenting data into messages, which may differ from default protocol parameters. Examples include application-specific segment sizes and optimized message lengths for particular data types.

As used herein, the term "packet processing circuitry" may refer to hardware components responsible for handling network packet operations, including segmentation, transmission, and protocol processing. Examples include network processor units and dedicated RDMA processing engines.

As used herein, the term "application" may refer to a software program running on a host computing device that utilizes network services to transmit or receive data. Examples include video streaming applications and high-frequency trading systems.

As used herein, the term "buffer offset pointer" may refer to an internal hardware mechanism that tracks the current position within a data buffer during processing operations. Examples include read pointers for sequential data access and write pointers for buffer management.

As used herein, the term "remaining buffer length" may refer to the amount of data in a buffer that has not yet been processed or transmitted, typically decremented as data is consumed. Examples include bytes remaining to be sent and unprocessed data counts.

As used herein, the term "current position" may refer to the specific location within a data buffer or data structure that is being accessed or processed at a given time. Examples include byte offsets within memory buffers and queue entry positions.

As used herein, the term "multicast transmission" may refer to a communication method where data is sent simultaneously to multiple recipients over a network using a single transmission operation. Examples include video streaming to multiple viewers and data distribution to server clusters.

As used herein, the term "multicast messages" may refer to data units that are transmitted to multiple destinations simultaneously using multicast addressing and routing mechanisms. Examples include broadcast packets and group communication messages.

As used herein, the term "sequencing" may refer to the ordering and numbering of messages or packets to ensure proper delivery and reassembly at the receiving end. Examples include packet sequence numbers and message ordering protocols.

As used herein, the term "single packet" may refer to one discrete unit of network data that fits within the constraints of the transport protocol and network infrastructure. Examples include individual Ethernet frames and standalone UDP datagrams.

As used herein, the term "multiple packets" may refer to a collection of network data units that together comprise a larger message or data transmission. Examples include fragmented IP packets and segmented TCP streams.

As used herein, the term "segmentation" may refer to the process of dividing larger data units into smaller, manageable pieces that conform to network or protocol constraints. Examples include IP fragmentation and RDMA message splitting.

As used herein, the term "automatic segmentation" may refer to hardware or system-level processes that divide data into appropriate segments without requiring manual intervention from applications. Examples include hardware-based packet segmentation and protocol-level message splitting.

As used herein, the term "computing system" may refer to an integrated collection of hardware and software components that work together to perform computational tasks and data processing operations. Examples include data centers and high-performance computing clusters.

As used herein, the term "remote computing device" may refer to a computing system that is physically or logically separated from the local system but connected through a network for communication purposes. Examples include remote servers and distributed computing nodes.

As used herein, the term "receive work requests" may refer to work queue elements posted by applications to specify where incoming network data should be placed in memory. Examples include RDMA receive requests and buffer posting operations.

As used herein, the term "receive buffers" may refer to memory regions designated for storing incoming network data, typically associated with receive work requests. Examples include pre-allocated memory areas and circular buffer structures.

As used herein, the term "facilitating transmission" may refer to the process of enabling, supporting, or managing the transfer of data over a network through various hardware and software mechanisms. Examples include packet forwarding and protocol processing.

As used herein, the term "maintaining" may refer to the ongoing management, tracking, or preservation of system state, data structures, or operational parameters. Examples include keeping buffer pointers current and preserving queue state information.

As used herein, the term "iteratively updating" may refer to the repeated modification of values or states through successive operations or processing cycles. Examples include incrementing buffer offsets and decrementing remaining data counts.

As used herein, the term "specifying" may refer to the act of defining, indicating, or providing specific parameters, values, or characteristics for system operations. Examples include setting buffer addresses and defining message sizes.

As used herein, the term "associating" may refer to the process of linking, connecting, or establishing relationships between different system components or data elements. Examples include pairing work requests with queue pairs and connecting buffers with memory keys.

As used herein, the term "configuring" may refer to the process of setting up, adjusting, or establishing parameters and settings for system components or operations. Examples include setting transport protocol parameters and establishing queue pair attributes.

As used herein, the term "single" when referring to work queue elements, completion notifications, or packets, may refer to one individual instance or unit of the specified component. Examples include one WQE per buffer transmission and one completion event per work request.

As used herein, the term "multiple" when referring to packets, work requests, or receive work requests, may refer to more than one instance of the specified component working together or in sequence. Examples include several packets forming a message and numerous work requests in a queue.

As used herein, the term "plurality of" when referring to messages or receive buffers, may refer to a collection or group of two or more instances of the specified component. Examples include multiple messages from buffer segmentation and several receive buffers for incoming data.

As used herein, the term "minimum of" may refer to the smallest value among a set of compared values or parameters, typically used in calculations or decision-making processes. Examples include choosing the smaller of remaining buffer length or MTU size and selecting the lowest available bandwidth.

As used herein, the term "different" when referring to buffers or custom message sizes, may refer to distinct, varied, or non-identical instances of the specified component. Examples include separate memory regions for various data types and varying segment sizes for different applications.

### SYSTEM DESCRIPTION

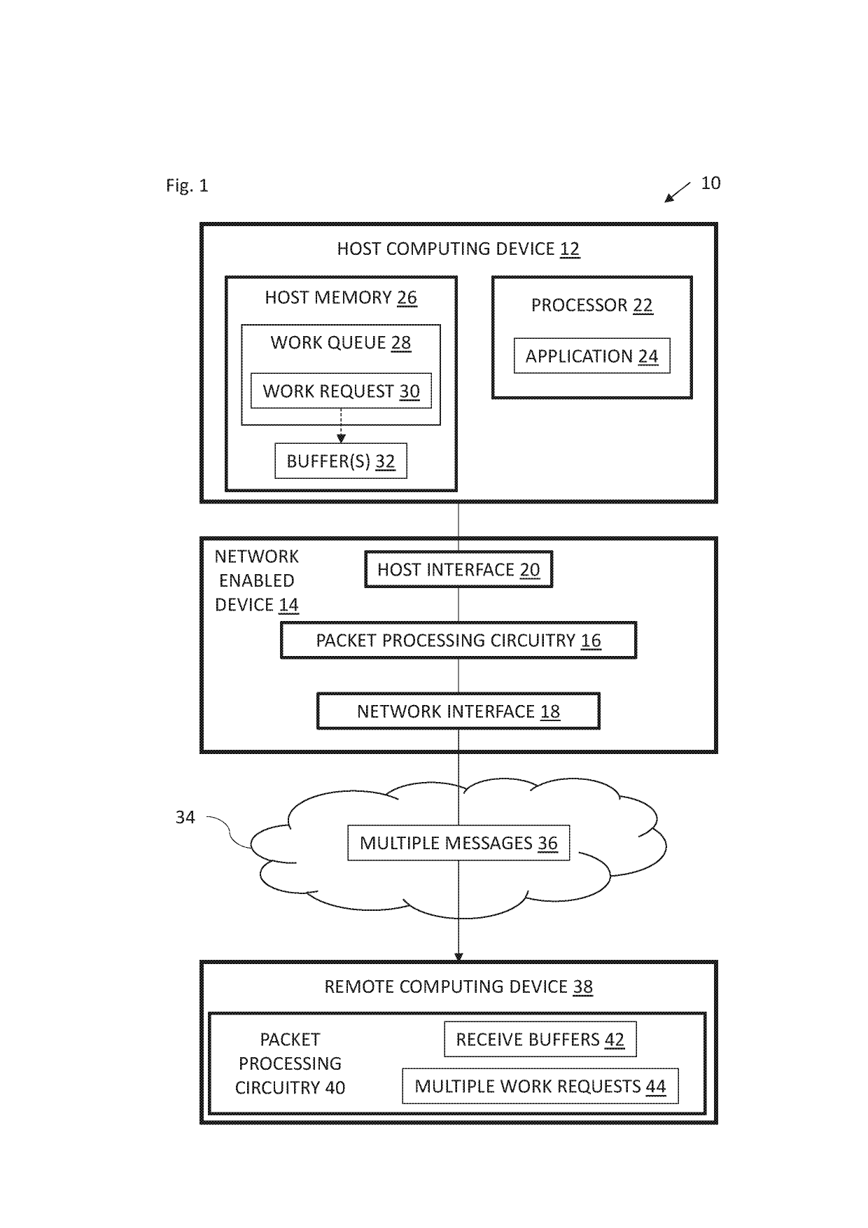

Reference is now made to FIG. 1, which illustrates a computing system 10 configured for optimized multi-message transmission using Remote Direct Memory Access (RDMA) protocols or any suitable protocol. The computing system 10 may include a host computing device 12 and a network enabled device 14 that are interconnected to facilitate efficient data transmission over a network 34.

The host computing device 12 may be coupled to the network enabled device 14 through a host interface 20. The host interface 20 may be configured to connect with the host computing device 12 and facilitate communication between the host computing device 12 and the network enabled device 14. In some cases, the host interface 20 may comprise a PCIe interface or other suitable high-speed interconnect technology.

The network enabled device 14 may include packet processing circuitry 16 configured to process data transmission requests and manage network communications. The network enabled device 14 may also include a network interface 18 configured to facilitate transmission of messages over the network 34. The network interface 18 may connect the network enabled device 14 to the network 34, enabling communication with remote devices.

The host computing device 12 may include a processor 22 configured to execute an application 24. The application 24 may generate data transmission requests (e.g., work requests) that are processed by the network enabled device 14. The host computing device 12 may also include host memory 26 configured to store data and control structures used in RDMA operations or other transportation operations.

The host memory 26 may contain a work queue 28 configured to hold work requests for processing by the network enabled device 14. The work queue 28 may include a work request 30 generated by the application 24. The work request 30 may specify one or more buffers 32 containing data to be transmitted over the network 34. In some cases, the work request 30 may be associated with a queue pair configured for a transport protocol.

The packet processing circuitry 16 may be configured to receive the work request 30 generated by the application 24 running on the host computing device 12. The packet processing circuitry 16 may process the work request 30 to automatically segment the buffer(s) 32 into a plurality of messages 36. The messages 36 may be transmitted over the network 34 according to the configured transport protocol.

The transport protocol may be an Unreliable Datagram (UD) protocol, which may operate as an unreliable, connectionless communication protocol that supports both unicast and multicast transmission. In some cases, the transport protocol may be a Reliable Connected (RC) protocol, which may provide reliable, connection-oriented communication where messages may be automatically split by hardware into multiple packets. The transport protocol may also be an Unreliable Connected (UC) protocol, which may provide unreliable, connection-oriented communication with characteristics similar to RC but without reliability guarantees. The computing system 10 may be applicable to various transport types including UD, RC, UC, and other RDMA transport protocols or non-RDMA transport protocols.

The network 34 may carry the messages 36 to a remote computing device 38. The remote computing device 38 may be configured to receive the plurality of messages 36, which were generated from a single work request 30 on the sender side, through a plurality of receive work requests on the receiver side. The remote computing device 38 may include packet processing circuitry 40 configured to process incoming messages. The remote computing device 38 may also include receive buffers 42 configured to store received data and multiple work requests 44 configured to handle the incoming messages 36, where each of the multiple work requests 44 corresponds to one of the messages 36 that originated from the single work request 30.

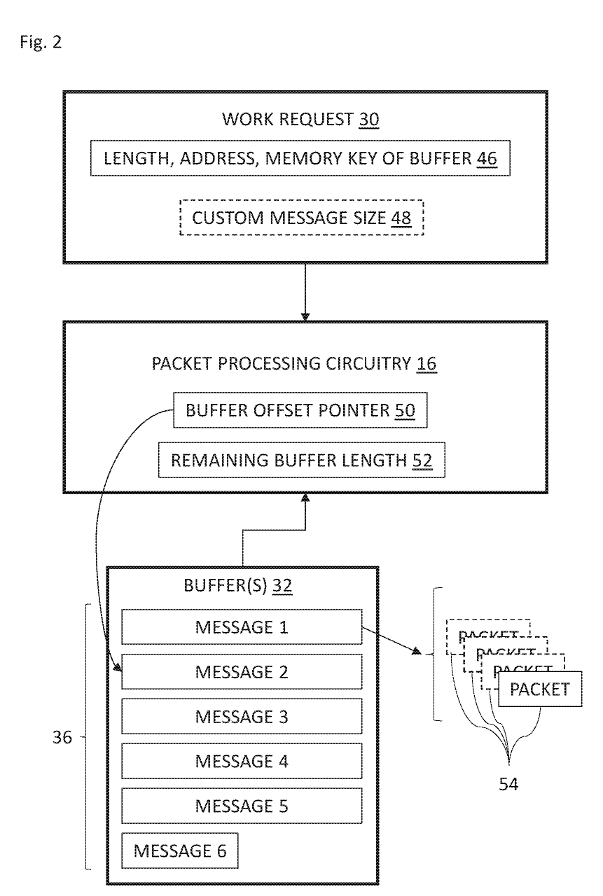

Reference is now made to FIG. 2, which illustrates detailed processing and transmitting of messages in the computing system 10 of FIG. 1. The work request 30 may specify buffer parameters 46 that include buffer data such as a length, address, and memory key of buffer 32. In some cases, the work request 30 may also include a custom message size 48 that defines how buffer 32 should be segmented into messages 36.

The packet processing circuitry 16 may be configured to maintain an internal buffer offset pointer 50 to track a current position within buffer 32 during segmentation. Additionally, the packet processing circuitry 16 may maintain a remaining buffer length 52 that indicates how much of buffer 32 remains to be processed. In some cases where the work request 30 contains multiple buffers, each buffer may have its own length, address, and memory key, and the packet processing circuitry 16 may maintain internal buffer offset pointers that track the current position within the multiple buffers.

The packet processing circuitry 16 may be configured to process the work request 30 to automatically segment buffer 32 into a plurality of messages 36, with each message having a message size. As shown in FIG. 2, buffer 32 may be segmented into messages 36 labeled as MESSAGE 1 through MESSAGE 6. In some cases, the first five messages (MESSAGE 1 through MESSAGE 5) may have the same message size, while MESSAGE 6 may be shorter as that message comprises the data remaining in buffer 32 after the other messages have been generated.

The message size for segmentation may be configured in various ways depending on the transport protocol and application requirements. In some cases, the message size for segmentation may be configured to match the Maximum Transfer Unit (MTU) size. In other cases, the message size for segmentation may conform to transport-specific limitations such as a 2-gigabyte maximum message size in RC implementations. When the work request 30 specifies a custom message size 48, the packet processing circuitry 16 may be configured to segment buffer 32 into the plurality of messages 36 using the custom message size 48.

The packet processing circuitry 16 may be configured to iteratively update the buffer offset pointer 50 and the remaining buffer length 52 until all of buffer 32 has been segmented. During this process, the packet processing circuitry 16 may calculate the message size for each message as a minimum of the remaining buffer length 52 and a configured message size. The hardware segmentation process may continuously evaluate the total buffer length against the remaining data to be transmitted in an iterative manner.

In some cases, the hardware processing logic may recognize and handle work queue elements that contain one or more buffers intended for segmentation into multiple messages. The hardware may identify the work request 30 as a multi-message transmission request and initiate a segmentation process. The hardware may construct each message containing data from the current buffer offset position, transmit the message according to transport protocol specifications, and update the buffer offset pointer 50 and remaining buffer length 52 accordingly.

The transport protocol configuration may determine how each message 36 is transmitted as packet(s) 54. In some cases, each message may correspond to a single packet that does not exceed a maximum transfer unit size. This may occur in UD transport, where each message corresponds to a single packet constrained by the MTU size, and each work queue element corresponds to one message in conventional implementations. In UD transport, every message may be exactly one packet due to protocol limitations.

In other cases, each message may be transmitted as multiple packets according to the transport protocol. This may occur in RC transport, where a single work queue element traditionally handles one message that may be automatically split by hardware into multiple packets according to the MTU or other protocol-specific size limitations configured in the queue pair. Each message may be a combination or sequence of multiple packets which the protocol specifies are part of the same message.

The packet processing circuitry 16 may be configured to transmit the plurality of messages 36 over a network according to the transport protocol. The buffer 32 may be split to MTU size or a specific size which is defined in the work request 30. The approach may provide per-WQE configurability for message size, allowing different segmentation strategies for different transmission requirements within the same queue pair. The approach may allow applications to post one work queue element containing one or more buffers, which the hardware automatically segments into multiple messages without requiring application-level buffer management or multiple work queue element postings.

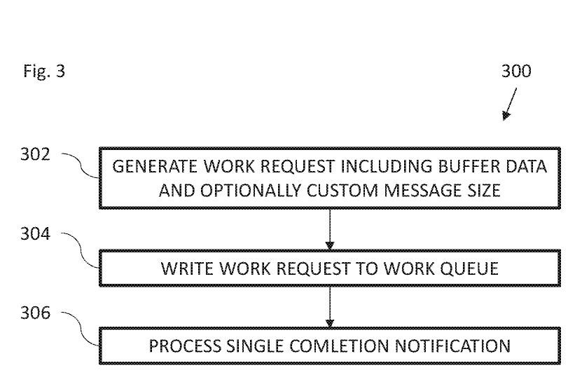

Reference is now made to FIG. 3, which is a flowchart of a method 300 for processing work requests by application 24 run by processor 22 of host computing device 12. The method 300 demonstrates how application 24 may interact with the multi-message transmission optimization system to achieve efficient data transmission while maintaining simplified application-level handling.

The method 300 begins with a step 302 of generating a work request including buffer data and optionally a custom message size. In step 302, application 24 may be configured to create a work request that specifies at least one buffer 32 containing data to be transmitted. The work request may include buffer parameters such as buffer address, length, and memory key information. In some cases, application 24 may specify a custom message size within the work request, allowing application 24 to control how the buffer data will be segmented into individual messages. The work request may be implemented as a single work queue element that contains all necessary information for the packet processing circuitry 16 to perform the multi-message transmission.

Following step 302, the method 300 proceeds to a step 304 of writing the work request to a work queue. In step 304, application 24 may be configured to post the generated work request to work queue 28 located in host memory 26. The work queue 28 may serve as a communication mechanism between application 24 and packet processing circuitry 16 of network enabled device 14. By writing the work request to work queue 28, application 24 may initiate the multi-message transmission process without requiring multiple separate work queue postings for each message segment.

The method 300 then moves to a step 306 of processing a single completion notification, which may be generated by packet processing circuitry 16 of network enabled device 14 after all the messages generated for the work request have been transmitted. In step 306, application 24 may be configured to handle a single completion notification rather than multiple completion notifications that would traditionally correspond to each individual message transmission. This single completion notification may indicate that all messages corresponding to the at least one buffer have been successfully transmitted over the network according to the transport protocol.

The application 24 may be configured to receive multiple work requests associated with different buffers for the same queue pair, where different ones of the work requests may specify different custom message sizes. This flexibility may allow application 24 to configure one work queue element to segment at least one buffer into smaller messages for certain requirements, while a subsequent work queue element on the same queue pair may use larger messages for different efficiency considerations, or vice-versa. Such per-work-request configurability may provide advantages over approaches where segmentation parameters are fixed at the queue pair level and cannot be modified on a per-transmission basis.

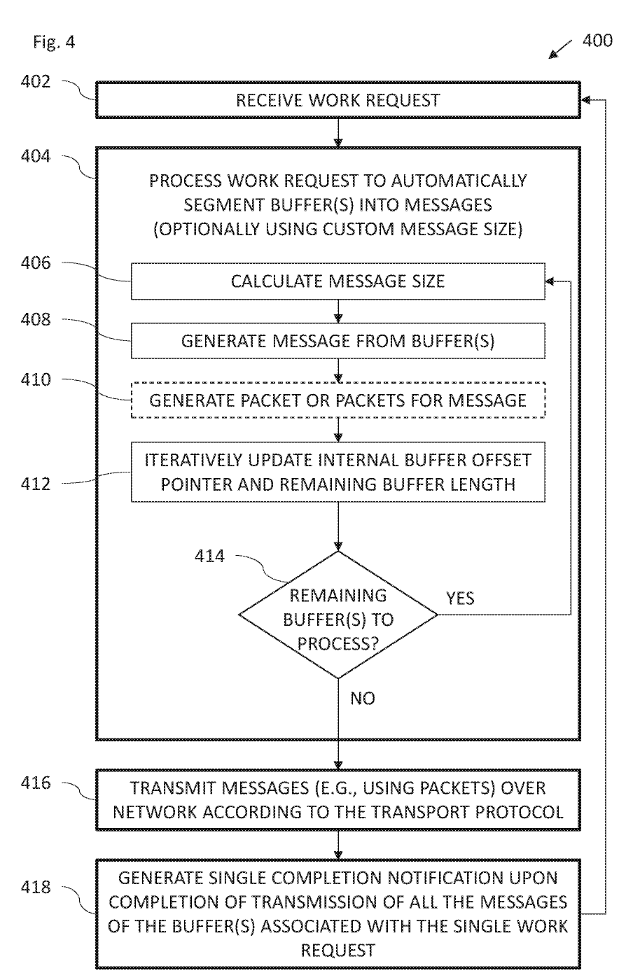

Reference is now made to FIG. 4, which illustrates a flowchart of a method 400 for multi-message transmission optimization performed by packet processing circuitry 16 of network enabled device 14. The method 400 demonstrates how packet processing circuitry 16 is configured to efficiently process work requests and automatically segment buffer data into multiple messages for transmission over a network according to a transport protocol.

The method 400 begins at step 402, where packet processing circuitry 16 is configured to receive a work request generated by application 24 running on host computing device 12. The work request may specify at least one buffer 32 and may be associated with a queue pair configured for a transport protocol. In some cases, the work request may be a single work queue element that contains buffer parameters and configuration information for the segmentation process.

Following step 402, the method 400 proceeds to step 404, where packet processing circuitry 16 is configured to process the work request to automatically segment the buffer(s) 32 into a plurality of messages 36. Step 404 may include several substeps that enable the automatic segmentation functionality.

Substep 406 may involve packet processing circuitry 16 calculating a message size for each message based on the remaining buffer length and configured parameters. The message size calculation may follow a hierarchical approach where the packet processing circuitry 16 first determines the maximum allowable message size based on the transport protocol configuration. For UD transport, this maximum may be constrained by the MTU size, while for RC transport, it may be limited by protocol-specific constraints such as a 2-gigabyte maximum or other implementation-defined limits. When the work request specifies a custom message size 48, the packet processing circuitry 16 may use this custom value as the target message size, provided it does not exceed the transport protocol limitations. The actual message size for each iteration may then be calculated as the minimum of three values: the remaining buffer length 52, the configured maximum message size (whether MTU-based, transport-limited, or custom), and any additional constraints imposed by the specific transport implementation. This calculation ensures that each message conforms to protocol requirements while efficiently utilizing the available buffer data, with the final message in the sequence potentially being smaller than the configured size when the remaining buffer length is less than the target message size.

A substep 408 may involve packet processing circuitry 16 generating a message from the buffer(s) 32 using the calculated message size. During substep 408, packet processing circuitry 16 may extract data from buffer(s) 32 starting at a current buffer position and continuing for the determined message length. Each message generated during substep 408 may include appropriate sequencing according to the transport protocol, ensuring that receiving devices can properly process the transmitted data.

An optional substep 410 may involve packet processing circuitry 16 generating one or more packets for each message according to the transport protocol configuration. In some cases, each message may correspond to a single packet that does not exceed a maximum transfer unit size, for example when the transport protocol operates in an unreliable datagram mode. In other cases, each message may be transmitted as multiple packets according to the transport protocol, such as when the message size exceeds packet size limitations.

A substep 412 may involve packet processing circuitry 16 iteratively updating an internal buffer offset pointer 50 and a remaining buffer length 52. During substep 412, packet processing circuitry 16 may advance buffer offset pointer 50 by the size of the message just processed and may decrease remaining buffer length 52 by the same amount. This iterative updating process enables packet processing circuitry 16 to track the current position within buffer(s) 32 and determine how much data remains to be processed.

The method 400 may include a decision block 414 that determines whether there are remaining buffer contents to process. Decision block 414 may evaluate remaining buffer length 52 to determine if additional messages need to be generated from buffer 32. If remaining buffer length 52 indicates that data remains to be processed, the method 400 may return to step 404 to continue the segmentation process. This iterative process may continue until all of the buffer(s) 32 has been segmented into messages 36.

When decision block 414 determines that no remaining buffer contents require processing, the method 400 may proceed to step 416. At step 416, packet processing circuitry 16 may be configured to transmit the plurality of messages 36 over network 34 according to the transport protocol. In some cases, the transport protocol may support multicast transmission, and the plurality of messages 36 may be transmitted as multicast messages to multiple receiving devices simultaneously. Each segmented portion may be transmitted as an independent message with its own sequencing appropriate to the transport type, enabling receiving devices to process each message separately while maintaining protocol compliance.

In some embodiments, the packet processing circuitry 16 may be configured to transmit messages 36 for a given work request 30 while other messages of the same work request are still being generated or still need to be generated from the buffer(s) 32. This pipelined approach may allow for overlapping of message generation and transmission operations, potentially improving overall throughput and reducing latency. The packet processing circuitry 16 may initiate transmission of completed messages without waiting for the entire buffer segmentation process to finish, enabling more efficient utilization of network resources and processing capabilities.

The method 400 may conclude with step 418, where packet processing circuitry 16 may be configured to generate a single completion notification upon completion of transmission of all messages 36 corresponding to the buffer(s) 32 associated with the single work request 30. Step 418 may provide application 24 with a single completion event rather than multiple completion events that would traditionally correspond to multiple work requests. This single completion notification may reduce the processing overhead on host computing device 12 and may simplify buffer management for application 24.

The method 400 may enable significant performance improvements by allowing application 24 to post a single work request while achieving the transmission of multiple messages 36. In some cases, packet processing circuitry 16 may receive multiple work requests associated with different buffers for the same queue pair, and different work requests may specify different custom message sizes, providing flexibility in how data segmentation occurs on a per-request basis.

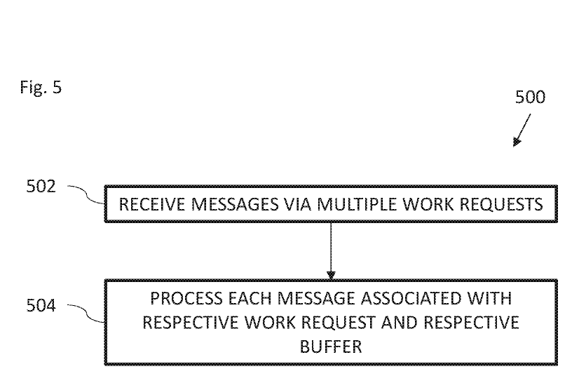

Reference is now made to FIG. 5, which illustrates a method 500 for processing messages at remote computing device 38. The method 500 demonstrates how remote computing device 38 may be configured to receive and process messages 36 that were transmitted from network enabled device 14 using the multi-message transmission optimization described herein.

The method 500 begins with a step 502 of receiving messages via multiple work requests 44. In step 502, packet processing circuitry 40 of remote computing device 38 may receive the plurality of messages 36 that were generated from the single work request 30 on the sender side. Each of the messages 36 may be received through a corresponding one of the multiple work requests 44. The remote computing device 38 may comprise a plurality of receive buffers 42, where each receive buffer 42 may correspond to one of the plurality of messages 36.

The method 500 then proceeds to a step 504 of processing each message associated with respective work request and respective receive buffer 42. In step 504, packet processing circuitry 40 may process each of the received messages 36 individually, with each message 36 being handled by its corresponding work request from the multiple work requests 44 and stored in its respective receive buffer 42.

The receiver-side operation may remain unchanged from standard protocol behavior, ensuring compatibility with existing RDMA implementations, for example. Each segmented message 36 may appear to packet processing circuitry 40 of remote computing device 38 as an independent message with appropriate headers for the transport protocol, even though the messages 36 as a whole were associated with the single work request 30 on the sender side. The receiving application running on remote computing device 38 may post the appropriate number of receive work queue elements to handle the incoming messages 36 without knowledge of the sender-side optimization performed by network enabled device 14.

This transparent operation may allow existing systems to interoperate seamlessly with systems implementing the multi-message transmission optimization. The remote computing device 38 may process the received messages 36 according to standard protocol procedures, with no modifications needed to accommodate the sender-side optimization that generated multiple messages 36 from the single work request 30.

In some embodiments, the network-enabled device may support transmission of buffers exceeding size limitations present in conventional transport implementations. Traditional transport protocols may impose restrictions on message sizes, such as a 2-gigabyte limitation in some RC implementations due to packet serial number constraints. The packet processing circuitry may overcome these limitations by segmenting large buffers into multiple independent messages, where each message conforms to the transport protocol specifications while the total buffer size may exceed conventional limits.

The total buffer size may be limited primarily by the application's memory constraints and system capabilities rather than protocol limitations. Since each segmented portion may be transmitted as an independent message with appropriate sequencing according to the transport protocol, applications may transmit data sets that would otherwise be restricted by traditional protocol boundaries. This capability may enable transmission of buffers larger than 2 gigabytes or other size restrictions that may exist in conventional implementations.

The packet processing circuitry may provide substantial reductions in CPU overhead and PCI bandwidth consumption while preserving the characteristics of the underlying transport protocol. By processing a single work request instead of multiple work requests for large buffer transmissions, the host computing device may avoid redundant operations associated with posting multiple work queue elements and processing multiple completion notifications. The reduction in PCI transactions may result from decreased work queue access patterns and simplified completion handling.

The network-enabled device may eliminate the need for applications to implement complex queue management strategies when handling large data transmissions. In conventional systems, applications may exhaust send queue capacity when transmitting large amounts of data, requiring sophisticated queue management to handle multiple work requests. The packet processing circuitry may address this limitation by enabling transmission of large buffers through a single work request, regardless of the send queue size constraints.

Alternative embodiments may include different transport protocol configurations beyond those specifically described. The packet processing circuitry may support various RDMA and non-RDMA transport types, including but not limited to Unreliable Datagram, Reliable Connected, and Unreliable Connected protocols. Each transport type may have different characteristics regarding reliability, connection requirements, and multicast support, and the segmentation approach may be adapted accordingly.

Various message sizing strategies may be implemented in different embodiments. The packet processing circuitry may determine message sizes based on maximum transfer unit configurations, transport-specific limitations, custom sizes specified in work requests, or dynamic sizing based on network conditions. Different work requests within the same queue pair may specify different message sizes, providing flexibility for varying transmission requirements.

Different buffer configurations may be supported in alternative embodiments. The work request may specify multiple buffers with different lengths, addresses, and memory keys. The packet processing circuitry may maintain separate buffer offset pointers and remaining buffer lengths for each buffer, enabling complex data transmission patterns from non-contiguous memory regions.

Alternative hardware implementations may include different packet processing architectures. The packet processing circuitry may be implemented using dedicated hardware accelerators, programmable processing units, or hybrid approaches combining hardware and software components. The segmentation logic may be distributed across multiple processing elements or integrated into existing RDMA processing pipelines.

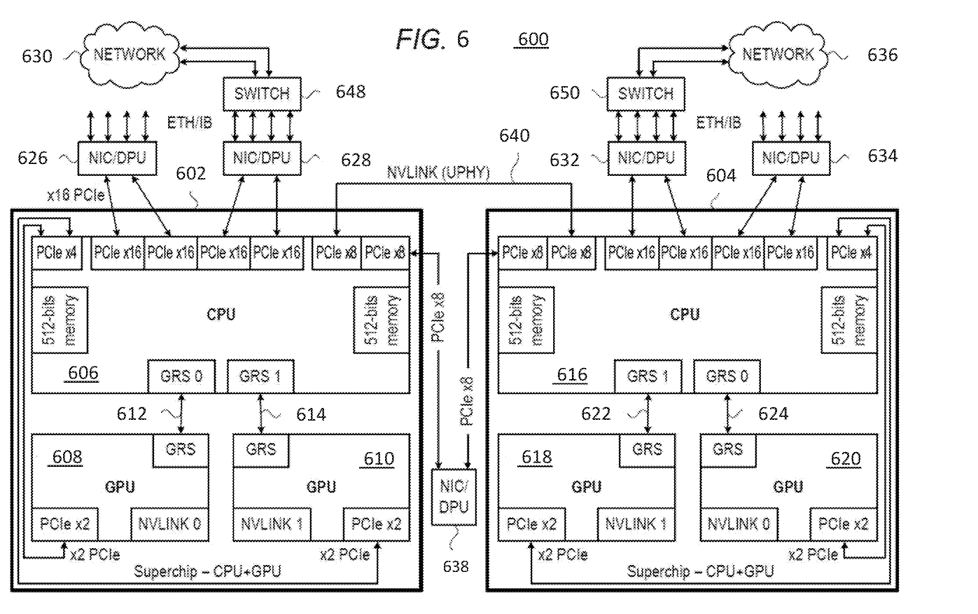

Reference is now made to FIG. 6, which is a block diagram that schematically illustrates a computing system 600, e.g., a data center or a High-Performance Computing (HPC) cluster, in accordance with an embodiment of the present disclosure.

System 600 comprises a plurality of subsystems, e.g., multiple processing devices coupled to each other, multiple network devices, and multiple networks, according to at least one embodiment. Computing system 600 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 600 and to one or more external networks 630, 636. In the present example, system 600 comprises a packet switch 648 that connects NIC/DPU 628 to network 630, and a packet switch 650 that connects NIC/DPU 632 to network 636.

The coupling of processing devices through NVLink allows for seamless data exchange and parallel processing, enhancing overall computational performance. The processing devices are connected to multiple networks through one or more network interface cards (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 600 can include one or more CPUs and one or more GPUs.

FIG. 6 also demonstrates an example architecture of a multi-GPU architecture. As illustrated in the figure, computing system 600 includes a processing device 602 with a multi-GPU architecture. In particular, processing device 602 may be a system-on-chip and includes multiple subsystems such as a CPU 606, a GPU 608, and a GPU 610. CPU 606 can be coupled to GPU 608 via a die-to-die (D2D) or chip-to-chip (C2C) interconnect 612, such as a Ground-Referenced Signaling interconnect (GRS interconnect). CPU 606 can be coupled to GPU 610 via a D2D or C2C interconnect 614. CPU 606 can also couple to GPU 608 and GPU 610 via PCIe interconnects.

CPU 606 can be coupled to one or more NICs or DPUs, which are coupled to one or more networks. For example, as illustrated in FIG. 6, CPU 606 is coupled to a first NIC/DPU 626, which is coupled to a network 630. CPU 606 is also coupled to a second NIC/DPU 628, which is coupled to network 630 via switch 648. NIC/DPU 626 and NIC/DPU 628 can be coupled to network 630 over Ethernet (ETH), NVLINK or InfiniBand (IB) connections, for example.

Computing system 600 also includes a processing device 604 with a multi-GPU architecture. In particular, processing device 604 includes multiple subsystems including a CPU 616, a GPU 618, and a GPU 620. CPU 616 can be coupled to GPU 618 via a D2D or C2C interconnect 622. CPU 616 can be coupled to GPU 620 via a D2D or C2C interconnect 624. CPU 616 can also couple to GPU 618 and GPU 620 via PCIe interconnects. CPU 616 can be coupled to one or more NICs or DPUs, which are coupled to one or more networks. For example, as illustrated in FIG. 6, CPU 616 is coupled to a first NIC/DPU 632, which is coupled to a network 636. CPU 616 is also coupled to a second NIC/DPU 634, which is coupled to network 636 via switch 650. NIC/DPU 632 and NIC/DPU 634 can be coupled to network 636 over Ethernet (ETH), NVLINK or InfiniBand (IB) connections.

In at least one embodiment, processing device 602 and processing device 604 can communicate with each other via a NIC/DPU 638, such as over PCIe interconnects. Processing device 602 and processing device 604 can also communicate with each other over a high-bandwidth communication interconnect 640, such as an NVLink interconnect or other high-speed interconnects. The packet switches in FIG. 6 may comprise, for example, Nvidia Quantum-2 switches. The NICs/DPUs in the figure may comprise, for example, Nvidia Bluefield DPUs.

The network enabled device may be any suitable device, such as: an accelerator device; a processing device including a central processing unit (CPU) and/or a graphics processing unit (GPU); a host device connected to one or more peripheral devices; a peripheral device connected to another peripheral device and/or one or more host devices; a network device, e.g., a network interface controller (NIC) device, a data processing unit (DPU) or smart NIC including a NIC and one or more processing cores, or a network switch. One or more of the processing steps described herein may be performed by a CPU, GPU, DPU, NIC, or any suitable combination thereof.

The NIC may include any of the following: an Ethernet Port (RJ45 Connector), which is the physical interface where the network cable (usually an Ethernet cable) connects to the NIC and is used for wired network connections; packet processing hardware or circuitry, which is responsible for handling network communication and processes incoming and outgoing data packets and manages the network interface functions; a memory (such as RAM or ROM) to store temporary data, such as network packet buffers, configuration settings, and firmware, and helps in speeding up data transfer and processing; firmware, which is software programmed into the NIC's memory and controls the hardware operations and may perform firmware updates to improve performance or add new features to the NIC; LED Indicators that provide visual indicators of network status, common indicators including power status, network activity, and link speed; a bus Interface (e.g., PCI or PCIe) to connect the NIC to the host computer’s motherboard; a processor to handle network processing tasks as well as other processing tasks to offload work from the main CPU of the host device and improve network performance; a heat sink or cooling mechanism (e.g., for high-performance NICs), especially those used in servers, to prevent overheating; power management circuitry to ensure the NIC receives the correct amount of power and manages power consumption efficiently; and/or connector pins and circuitry including internal connections and pathways that route signals between the NIC's components.

The packet processing hardware or circuitry is the central component of the NIC and handles network communications. It may include several key components that work together to manage and process network data, such as any one or more of the following: MAC (Media Access Control) Layer, which is responsible for handling the data link layer of the OSI model and manages how data packets are formatted, addressed, and transmitted over the network; MAC address register, which stores the unique hardware address (MAC address) of the NIC; a frame buffer that temporarily holds data frames as they are being processed; a PHY (Physical Layer) Interface that interfaces with the physical medium (such as Ethernet cables) and is responsible for the actual transmission and reception of data bits over the network; a transceiver that converts data between the digital signals used by the MAC layer and the analog signals used for transmission over the network medium; DMA (Direct Memory Access) Controller that manages data transfers between the NIC and the computer’s memory without involving the CPU and helps to offload processing tasks from the CPU and improve data transfer efficiency; a packet Processing Engine that handles the encapsulation and decapsulation of network packets, and processes incoming and outgoing packets, managing tasks like error checking and packet filtering; buffer management, which includes memory areas for storing packets temporarily, such as transmit buffers to store packets that are being sent from the computer to the network, receive buffers to store packets received from the network before they are processed by the system; an interrupt controller that manages and generates interrupts to notify the CPU of events such as packet reception or transmission completion and helps in efficient handling of network events; a clock generator, which provides timing signals for the various components of the NIC to synchronize their operations; a power management unit to regulate power consumption and manages power-saving features of the NIC chip to improve energy efficiency; error handling and correction logic, which detects and corrects errors in data transmission and reception, and may include features for error-checking protocols like CRC (Cyclic Redundancy Check); configuration registers that store configuration settings and parameters that control the NIC’s operation, such as speed settings, interrupt configurations, and buffer sizes; firmware/ROM that contains the embedded software that controls the NIC’s operations and manages network protocols.

The network switch may include any of the following: ports where network cables connect; switching fabric that manages data transfer between ports; a MAC address table that stores device addresses and port information; a forwarding engine that directs data packets to the correct ports; buffer memory that temporarily holds data to manage traffic; a management processor that handles configuration and monitoring in managed switches; a power supply that provides electrical power; a cooling system that keeps the switch from overheating; firmware that controls the switch; LED Indicators that show status and activity; and networking modules (in modular switches) that allow for additional ports or features.

The quantities, numbers, and arrangements of the various elements described herein are provided by way of example and are not intended to be limiting. In various embodiments, the system may include any suitable number of processing devices, network switches, NICs, DPUs, GPUs, CPUs, interconnects, networks, ports, buffers, or other components as may be appropriate for a particular implementation. The specific quantities mentioned in the examples above may be scaled up or down depending on the requirements of the system, performance considerations, cost constraints, or other design factors. Additionally, the ratios and relationships between different components may be adjusted to optimize system performance for specific use cases or applications.

In practice, some or all of these functions may be combined in a single physical component or, alternatively, implemented using multiple physical components. These physical components may comprise hard-wired or programmable devices, or a combination of the two. In some embodiments, at least some of the functions of the processing circuitry may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

The various elements described herein as performing particular tasks or steps may be configured to, adapted to, operative to, designed to, programmed to, or otherwise arranged to perform such tasks or steps. In some embodiments, these elements may include hardware components, software modules, firmware, or any combination thereof that enable the performance of the described functionality. The elements may be implemented using processing circuitry, dedicated hardware, programmable logic, or other suitable technologies that allow for the execution of the specified operations. Additionally, these elements may be selectively activated, controlled, or coordinated to perform their respective functions as part of the overall system operation.

The flowchart and block diagrams in the Figures illustrate the architecture, functionality, and operation of possible implementations of systems, methods and computer program products according to various examples of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. The descriptions of the various examples of the present disclosure have been presented for purposes of illustration, but are not intended to be exhaustive or limited to the examples disclosed. Many modifications and variations will be apparent to those of ordinary skill in the art without departing from the scope and spirit of the described examples.

As used herein, the singular form "a", "an" and "the" include plural references unless the context clearly dictates otherwise.

Various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

The embodiments described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

What is claimed is:

1. A network-enabled device, comprising:
a host interface to connect with a host computing device;
packet processing circuitry to:
receive a work request generated by an application running on the host computing device, the work request specifying at least one buffer and being associated with a queue pair configured for a transport protocol;
process the work request to automatically segment the at least one buffer into a plurality of messages, each message having a message size; and
transmit the plurality of messages over a network according to the transport protocol; and
a network interface to facilitate transmission of the plurality of messages over the network.

2. The network-enabled device according to claim 1, wherein each message corresponds to a single packet that does not exceed a maximum transfer unit size.

3. The network-enabled device according to claim 1, wherein each message is to be transmitted as multiple packets according to the transport protocol.

4. The network-enabled device according to claim 1, wherein the work request specifies a custom message size, and the packet processing circuitry is to segment the at least one buffer into the plurality of messages using the custom message size.

5. The network-enabled device according to claim 1, wherein the packet processing circuitry is to maintain an internal buffer offset pointer to track a current position within the at least one buffer during segmentation.

6. The network-enabled device according to claim 5, wherein the packet processing circuitry is to iteratively update the buffer offset pointer and a remaining buffer length until all of the at least one buffer has been segmented.

7. The network-enabled device according to claim 6, wherein the packet processing circuitry is to calculate the message size for each message as a minimum of: the remaining buffer length; and a configured message size.

8. The network-enabled device according to claim 1, wherein the transport protocol supports multicast transmission, and the plurality of messages are transmitted as multicast messages.

9. The network-enabled device according to claim 1, wherein each message in the plurality of messages includes appropriate sequencing according to the transport protocol.

10. The network-enabled device according to claim 1, wherein the packet processing circuitry is to receive multiple work requests associated with different buffers for the queue pair, and wherein different ones of the work requests specify different custom message sizes.

11. The network-enabled device according to claim 1, wherein the packet processing circuitry is to generate a single completion notification for processing by the application upon completion of transmission of all of the messages corresponding to the at least one buffer.

12. The network-enabled device according to claim 1, wherein the work request is a single work queue element.

13. A computing system, comprising:
a host computing device running an application;
a network-enabled device coupled to the host computing device, the network-enabled device comprising:
a host interface to connect with the host computing device;
packet processing circuitry to receive a work request generated by the application, the work request specifying at least one buffer and being associated with a queue pair configured for a transport protocol, process the work request to automatically segment the at least one buffer into a plurality of messages, each message having a message size, and transmit the plurality of messages over a network according to the transport protocol; and
a network interface to facilitate transmission of the plurality of messages over the network; and
a remote computing device configured to receive the plurality of messages through a plurality of receive work requests.

14. The computing system according to claim 13, wherein the remote computing device comprises a plurality of receive buffers, each receive buffer corresponding to one of the plurality of messages.

15. The computing system according to claim 13, wherein each message corresponds to a single packet that does not exceed a maximum transfer unit size.

16. The computing system according to claim 13, wherein each message may be transmitted as multiple packets according to the transport protocol.

17. The computing system according to claim 13, wherein the work request specifies a custom message size, and the packet processing circuitry is to segment the at least one buffer into the plurality of messages using the custom message size.

18. The computing system according to claim 13, wherein the transport protocol supports multicast transmission, and the plurality of messages are transmitted as multicast messages.

19. The computing system according to claim 13, wherein the packet processing circuitry is to receive multiple work requests associated with different buffers for the queue pair, and wherein different ones of the work requests specify different custom message sizes.

20. The computing system according to claim 13, wherein the packet processing circuitry is to generate a single completion notification for processing by the application upon completion of transmission of all of the messages corresponding to the at least one buffer.

21. The computing system according to claim 13, wherein the work request is a single work queue element.

22. A method for multi-message transmission optimization, comprising:
receiving a work request generated by an application running on a host computing device, the work request specifying at least one buffer and being associated with a queue pair configured for a transport protocol;
processing the work request to automatically segment the at least one buffer into a plurality of messages, each message having a message size; and
transmitting the plurality of messages over a network according to the transport protocol.
